(19) United States
(12) Patent Application Publication
(10) Pub. No.: US 2002/0111833 A1
(43) Pub. Date: Aug. 15, 2002

(54) Method and apparatus for requesting and retrieving de-identified medical information

(76) Inventor: Richard S. Dick, Alpine, UT (US)

Correspondence Address: Kirton & McConkie, 1800 Eagle Gate Tower, 60 East South Temple, Salt Lake City, UT, 84111, US

(21) Appl. No.: 10/057,337

(22) Filed: Jan. 23, 2002

Related U.S. Application Data
(63) Continuation-in-part of application No. 09/596,810, filed on Jun. 19, 2000.

(51) Int. Cl. G06F 17/60

(52) U.S. Cl. 705/3

(57) ABSTRACT

The present invention relates to a method of searching for medical information. The method of searching may be executed by one or more computers and comprises the steps of receiving a request for medical information including identification of a subject; transmitting a query to a medical information repository for information pursuant to the request; and receiving a response to the query. The response to the request including information based on the response to the query may be further transmitted after being received. In addition, the response to the query may be de-identified to remove any identifying information therefrom.

### RELATED APPLICATIONS

This continuation in part application claims priority to U.S. patent application Ser. No. 09/596,810 filed Jun. 19, 2000, entitled Method and Apparatus for Requesting and Retrieving Medical Information.

### FIELD OF THE INVENTION

The invention relates generally to electronic access of medical information and more specifically to electronic access of medication, pharmaceutical, and clinical information.

### BACKGROUND OF THE INVENTION

### Common Uses for Medical Information

Common uses for medical information include physician reference and diagnosis, medical research, medical training, insurance policy underwriting and claims adjusting. Many fields of insurance (e.g., life, health, disability income, long term care, casualty, and reinsurance) routinely require medical information for analysis. Such analyses of medical information typically include reviewing attending physician's statements (“APS”) and other medical records. An APS is usually considered to be the most reliable record as it contains analyses and conclusions by a licensed medical professional. Medical records may be used to help determine the risk presented by an insurance applicant. Medical records can also help determine causation and other issues relevant to claims adjusting.

### Status of Medical Information

Medical records, including APSs, are generally available, but are not easily accessible. Because such records are highly sensitive, they are protected by ethics and by law requiring patient consent prior to disclosure. APSs and other medical records are typically restricted to paper documentation located in patient record rooms of physicians and other medical providers.

To avoid filling office and patient space with voluminous paper records, some medical providers are gradually migrating to computerized patient records systems (“CPRS”). Likewise, the number of providers employing retrospective conversion systems (“RCS”) to convert paper records to computerized images or computer readable records is gradually increasing. However, like their paper counterparts, CPRS and RCS records most often remain isolated from external sources.

### Difficulties Caused by the Status of Medical Information

It may take several weeks to receive a medical record after it is requested from a medical information repository such as a physician's office. The delay is due to the paper-only format of the records and the low priority assigned to such requests by medical providers. Since APSs and other medical records are generally restricted to paper, personnel time is required to locate, copy, and fax or mail copies to a requester; consequently requesters are charged an administrative fee for this service. The lengthy delay causes a multitude of problems for requesters. For example, a delay in obtaining medical records for use in underwriting insurance policies may cause applicants to lose interest, with a consequent loss of business to the insurer.

In an effort to shorten delays, some requesters utilize agents to travel to and manually retrieve medical records from medical providers. Although this may partially resolve the delay problem at significant expense, it does not address the problem of not knowing whether the retrieved record is complete, whether other records exist, or where more complete or other records may be located. This is a persistent problem with physician-based records and clinical records. Further, even when the existence and location of a record are known, its relevance remains uncertain until retrieved and reviewed. Because of the significant cost of manual retrieval, this is a substantial problem.

Just as insurance companies lack access to the medical records they need, health care providers and emergency medical technicians also have a need for access to medical records regarding patients which presently goes unmet. Health care providers and emergency medical technicians are sometimes required to make decisions regarding how to care for a patient under circumstances in which paper records such as physician-based records are not available. Prior art systems for obtaining and utilizing information from a patient's medical records fail to provide information that may be helpful or in some cases crucial for proper care of the patient. The prior art systems' shortcomings in this area increase the risk of improper treatment for the patient and increase the likelihood of malpractice by the healthcare providers and emergency medical technicians.

The present invention is directed to overcoming, or at least mitigating, one or more of the problems set forth above.

### SUMMARY OF THE INVENTION

Due to the present lack of electronically stored medical records which necessitates manual retrieval of paper records at high costs, in addition to other benefits which will be obvious to one skilled in the art, a novel method of accessing computer based medical records, generally, and surrogate information, in the form of electronically stored medication records, specifically, is disclosed. Similarly, a novel apparatus is disclosed.

An illustrative method in accordance with the present invention is disclosed, a method of searching for medical information executed by one or more computers comprising: receiving a request for medical information including identification of a subject and a signed information release form; transmitting a query to a medical information repository for information pursuant to the request; and receiving a response to the query containing medical information.

Accessing medication information as a surrogate solves or reduces the effects of cited problems in accessing more complete medical records and also provides additional benefits. For instance, instead of waiting several weeks to obtain information, medication information can be retrieved in near real-time since most pharmacy benefit managers (“PBM”s), healthcare plan systems (“HPS”s) and retail pharmacies (“RP”s) maintain electronic records. Further, PBMs, HPSs, and RPs are not overburdened by requests for information because computers handle requests for information. Next, since access is electronic, information requestors do not have to incur traditional fees for agents to travel to and retrieve the information. Also, because medication is usually prescribed for serious health problems relevant to insurance policy underwriting and claims handling, medication information can help focus the search for more complete and relevant medical records.

The present invention further contemplates the use of “de-identifying” methods and processes for allowing information from the present invention to be distributed for use in medical research. De-identified information comprises information that is void of any identifying information as described and taught herein, and as understood by one ordinarily skilled in the art.

### BRIEF DESCRIPTION OF THE DRAWINGS

FIG. 1 illustrates a flowchart of a preferred embodiment in accordance with the present invention.

FIG. 2 illustrates a flowchart of another embodiment of the present invention.

FIG. 3 illustrates several preferred physical environments in which the method of the preferred embodiment may be carried out.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

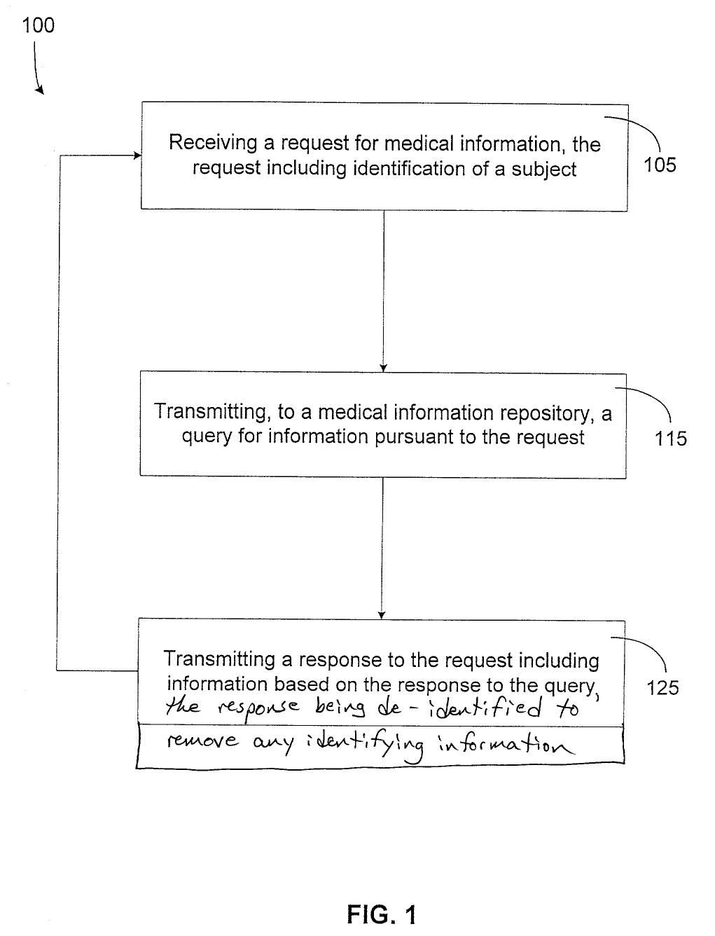

FIG. 1 shows a flowchart of a preferred embodiment, in accordance with the present invention. Medical Information 100 encompasses all information relating to physical and mental health diagnoses and remedies such as physician-patient records, clinical information records and prescription drug records. Clinical information includes laboratory testing, ambulatory, home health, and long-term care among other sources of clinical care and information.

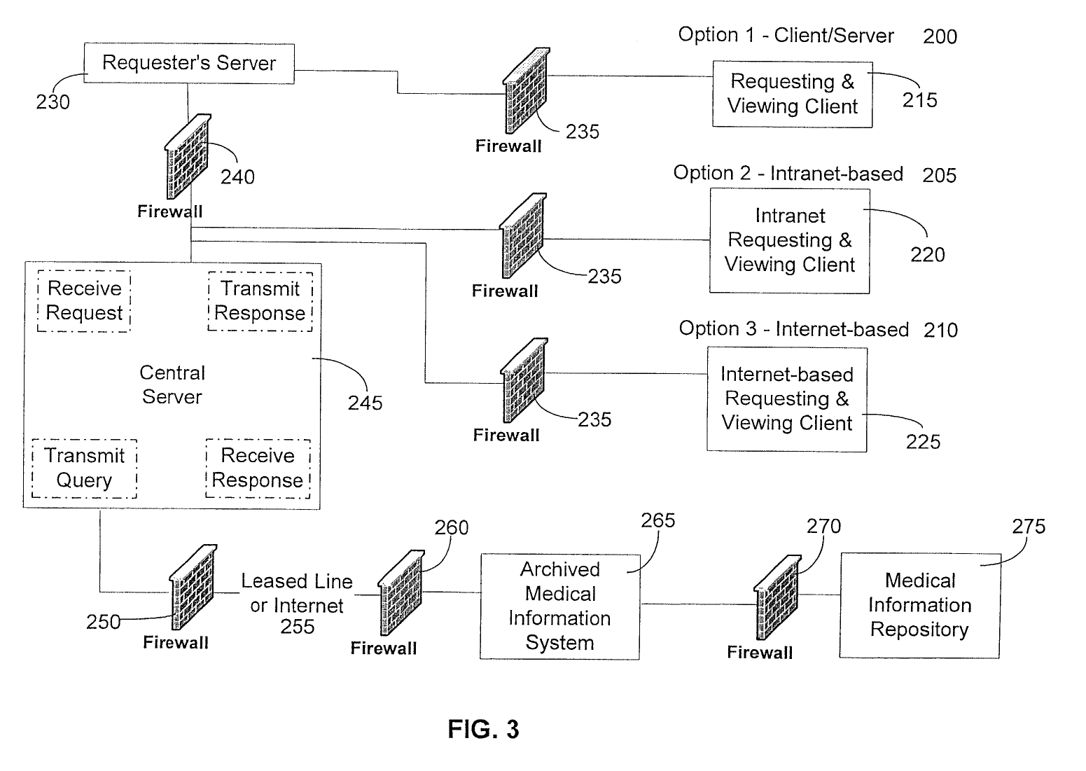

The illustrative method in FIG. 1 includes receiving a request for medical information including identification of a subject and a signed information release form 105; transmitting a query to a medical information repository for information pursuant to the request 115; and transmitting a response to the request for medical information, including information based on the response to the query 125. A variation of the method and system described in FIG. 1 includes the additional steps of verifying the request 110 and receiving a response to the query containing medical information 120. In aid of further description, the illustrative method in FIG. 1 will be described according to the several physical environments shown in FIG. 3.

FIG. 3 illustrates several preferred physical environments in which the preferred method 100 is carried out in search of medical information. Specifically, three front-end physical environments are shown, a client-server environment 200, an intranet-based environment 205, and an internet-based environment 210. Each front-end physical environment includes one or more requesting and viewing clients (“RVC”s), respectively, client-server-based 215, intranet-based 220, and internet-based 225.

An RVC is typically a terminal having at least a video display and keyboard. In general, each RVC is operated by an authorized user to request and subsequently review retrieved medical information or other search results. In light of the sensitive nature of medical information, security is of utmost importance. A variety of security measures could be employed to ensure that only authorized users obtain access.

Each RVC operates to receive a request for medical information according to its configuration. Generally, each RVC will receive such a request via an authorized user's responses to prompts generated by executing software displayed on the RVC video display. More specifically, a client-server RVC 215 would receive a request from an authorized user responding to prompts from software executing on requestor's server 230 or on RVC 215. An intranet-based RVC 220 would receive a request from an authorized user responding to prompts from software executed by RVC 220. An internet-based RVC 225 would receive a request from an authorized user responding to prompts from internet browser software executed by RVC 225 wherein the browser software is executing instructions received by an internet website accessed through the browser software.

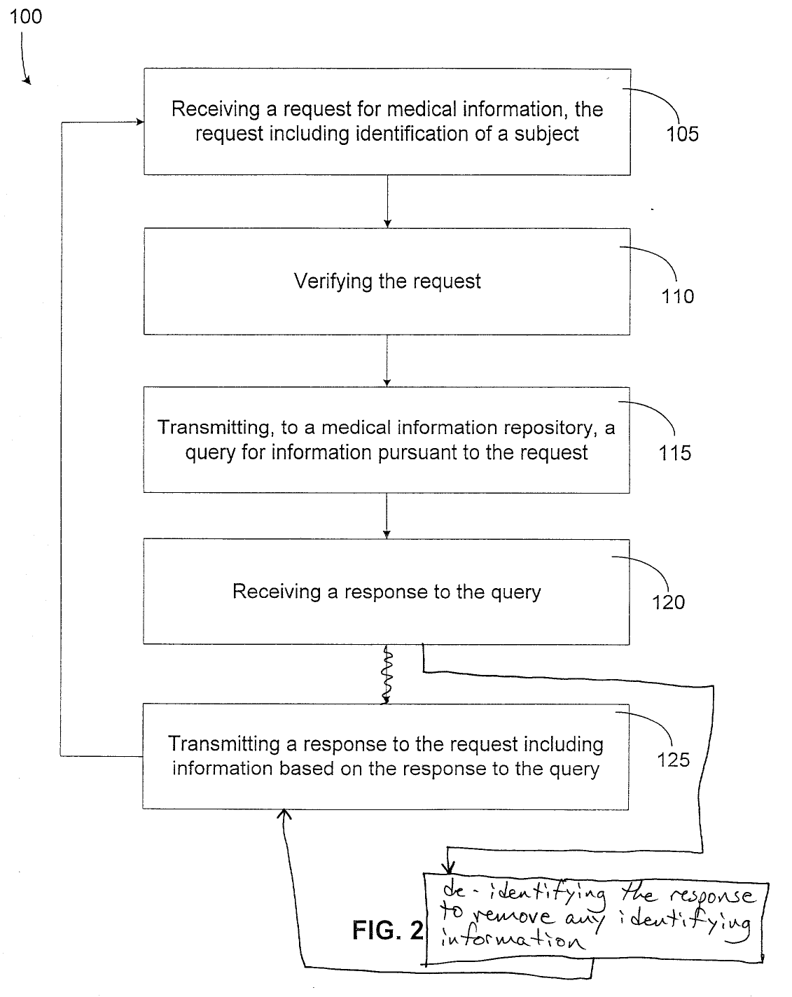

In each of the three physical environments shown, RVCs are protected by at least one firewall 235 to deter unauthorized access. In the case of the client-server RVC 215, three firewall layers are shown in FIG. 2, double firewall 240 in combination with firewall 235. An RVC is part of a network, wherein network is broadly defined to encompass any configuration of operably connected computers, including wired or wireless connectivity over an intranet, the internet, modems, phone lines, satellites, wireless transmitters and receivers, optical lines, firewalls, servers, relays, bridges, repeaters, etc.

Each request for medical information includes identification of a subject and, where required by law, a signed information release form. A subject might consist of a human individual or group of humans. The subject is the target of the search for medical information. The identification of the subject could be by way of name, patient number, social security number, driver's license number, address, phone number, biometric identification or any other identification or combination of identification characteristics capable of being correlated with stored medical information, if it exists.

The request may originate with any party desiring the medical information. The request may originate with insurance agencies, health care providers and professionals, and emergency medical technicians. In some embodiments of the present invention, the request originates with a medical information repository (MIR) itself. The request may be received directly by the MIR via an RVC controlled by the MIR or may be received by an RVC that then routes the request to the MIR. The term medical information repository includes but is not limited to pharmacy benefit managers (“PBM”s), pharmacies, and any other medical information repository such as a physician's office or clinical laboratory.

In some cases, consent of the subject(s) is required to obtain the medical information. In one embodiment of the present invention, a signed information release form is typically documentation of the subject's consent, or their legal representative's consent, to the disclosure of medical information. Such documentation can be in image or machine-readable format. The release form could become part of the request by a procedure that includes scanning in a signed paper-based release form, possibly modified by character recognition software, followed by pointing to the electronic location of the scanned release form in response to a prompt from requesting software displayed on an RVC. The necessity of scanning is eliminated if the subject or their authorized representative electronically signs an information release form. In some situations the requester may electronically certify their possession of a signed information release. In other instances, where the law does not require a release, none is obtained.

Once a request is received by an RVC, the request is transmitted to and received by a central server 245. A central server may consist of multiple computers performing specific tasks or executing independent processes. When central server 245 receives a request for medical information 105, it may optionally verify the request 110 before it sends a response to the request 125. Request verification 110 can take many forms, but most likely will be driven by the satisfaction of legal and security requirements. Verification is communicated to the request handling software executing on the central server 245. An example of request verification 110 includes electronic verification of an electronic watermark or digital certificate submitted with the request. A further example includes verification of the user identified as originating the request for information. However, if the RVC is an automatic requesting system without a user per se, the security focus would be on source recognition, for instance a recognized account code, a request authorization code assigned by software, a hardware address, or the like.

Following receipt of the request for information 105, the Central Server 245 will transmit a query to a medical information repository 275 for information pursuant to the request 115. The query may or may not include a copy of the signed information release form depending on the procedure in place at the medical information repository. As explained above, a medical information repository includes pharmacy benefit managers (“PBM”s), pharmacies, and any other medical information repository such as a physician's office or clinical laboratory. PBMs are companies contracted by health insurers and self-insured employers to manage prescription drug programs. The path of the transmitted query 115 to the medical information repository may include one or more firewalls, 250 and 260, as depicted in FIG. 2. Firewall 250 prevents unauthorized access to the central server 245. The particular method of communication is unimportant as long as information security measures are taken. The most common forms of communication are depicted in FIG. 2 as leased line or internet 255. In addition, an Archive Medical Information System (AMIS) server 265 may be accessed by the central server 245. AMIS server 265 will receive the transmitted query 115 and proceed to search the AMIS database for information in satisfaction of the query. To prevent unauthorized access, firewalls 250 and 260 protect the AMIS server.

A Universal Master Person Index (UMPI) may exist at the central servers 245 and will consist of a set of demographics and other specific information for identifying an individual, including pointers to other remote systems which may have relevant information about that individual. Similarly, an L-MPI (local MPI) may reside on the AMIS 265 and this will contain demographic and other specific information for the identification of the individual whose medication information resides on that particular AMIS 265. The purpose in both instances of the Master Person Index (MPI) is to enable the identification of an individual for whom a request is being made and to increase the speed and efficiency of retrieval.

There are several benefits to utilizing an AMIS server 265. The AMIS server 265 removes the computing burden from medical information repositories such as MIR 275 by processing requests for information. The AMIS server 265 also allows for system maintenance and upgrades without disrupting medical information repository systems. The AMIS server 265 can also be used to archive medical information for longer periods of time than may be established for MIR 275. The period of archival in the AMIS server 265 could be any length of time. The AMIS server 265 may be associated with one or more MIRs and may be networked with the MIR to receive data directly from the MIR or may be wholly removed from the MIR, receiving data indirectly.

When AMIS server 265 has completed information searches responsive to the query from central server 245, AMIS server 265 will transmit a response to central server 245 conveying the results of the search(es) made pursuant to the query/queries sent by central server 245. Central server 245 will thus receive one or more responses to its one or more queries 120. Following receipt of a response to its query 120, central server 245 will return a response to the request 125.

When central server 245 receives the response to its query 120, it will prepare a response to the request received 105 from an RVC. If more than one query was made, central server 245 will compile the responses to the queries prior to returning the response to the request 125. The response to the request will be based, at least in part, on information contained in the response to the query 120. Depending on the results of the search, the response to the request 125 may even convey no results if that is conveyed in the response to the query 120. Similarly, messages similar to “information repository unavailable” may be required from time to time.

The information requested from the various medical information repositories may be stored in formats that are generic, incompatible or in some way undesirable . When information relative to request is located by the search, the information may be advantageously compiled and reformatted. The AIMS server or the central server may operate to reformat and/or compile the responses received, before the response is ultimately transmitted to the intended receiver. The response may be advantageously reformatted in a several ways. For example, the information may be reformatted to facilitate transmission, to safeguard confidentiality, or to make the information more user friendly. Alternatively, if the various medical information repositories store medical information in formats that are incompatible or undesirable, the repositories themselves may be advantageously reformatted. The information received could also be advantageously reformatted by the RVC or by the intended recipient. Once properly formatted, the response to the request may be sent directly to the intended recipient from the MIR or AIMS. Alternatively the response may be transmitted to the intended recipient through the RVC.

Central server 245 may provide several additional value added functions to the response(s) to queries prior to transmitting a response to the request 125.These value added functions include but are not limited to reformatting, searching for and appending names, addresses, phone numbers, fax numbers of physicians or pharmacists referred to in the medical information, and providing interpretive information.

For example, medication information contained in the response may provide useful insights into the existence, location and importance of other medical records. Since medication information typically includes information about the physician prescribing medication by name and address or unique identifier, the probable location of medical information such as physician-based records may be determined from the medication information. Further, since the medication information typically includes the type of medication prescribed, the necessity of retrieving certain underlying physician-based records may be eliminated by review of the medication information.

In light of the complete computerization of the preferred embodiment, no human-induced delays are encountered. Thus, retrieval of medical information occurs in near real-time as opposed to the usual several week delay in obtaining physician-based records, clinical records, and other paper-based medical records. Because of the speedy retrieval of medical information and the elimination of the need to review irrelevant medical information, requestors such as insurance companies will not incur unnecessary expenses.

Additional benefits provided by a method implemented in accordance with the present invention, aside from overcoming the difficulties associated with the prior art, include: increased confidence in risk assessment through underwriting because medication information includes information about underlying physician-based records which otherwise may be unknown; more refined and cost effective risk analysis for smaller polices for which no extensive medical underwriting is typically performed; benefits for physicians and especially emergency care physicians for purposes of diagnosis; increased revenue for life insurance companies who lose business due to long delays in retrieving medical records; increased revenue for health insurance companies by eliminating duplicative testing via locating and utilizing recent test results in lieu of newly ordered tests; prompt retrieval of medical information relevant to mental and physical health analyses for legal and mental health fields; prompt retrieval of information for individuals concerned about the contents of their medical records.

In another embodiment, similar to the use of medication information as a surrogate for physician-patient records, clinical laboratory information such as blood and tissue testing and x-ray results may be utilized as a surrogate for physician-based records such as APSs. Clinical information similarly records tests ordered, results obtained, and the requesting physician. Thus, the foregoing description of the preferred embodiment with respect to medication information applies equally to clinical information.

In hindsight, it will be recognized by those of ordinary skill having the benefit of this disclosure, that information other than medication and clinical information can be used as a surrogate for physician-based records such as APSs. It is therefore evident that the particular embodiments may be altered or modified and all such variations are considered within the scope and spirit of the invention.

The value of the present system is not limited to its ability to efficiently obtain medical information for individuals. The system is also valuable in that it provides the possibility of gathering medical information relevant to groups of individuals or large populations. For example, the medical information that is retrievable using the present invention could also be valuable in medical research. Medical information made available by the present system for groups of individuals or large populations could improve the efficiency and quality of medical research.

Research and development of pharmaceuticals is one area of medical research for which the present invention could provide significant advantages. One of the most difficult tasks in conducting medical research for pharmaceuticals is finding human subjects that have a medical history profile appropriate for testing an experimental drug. Often researchers are left to purchasing advertising in print and broadcast media in order to solicit public participation in drug studies. These advertisements may be limited in their ability to convey to the listener the specific requirements for participating in the test and are limited in many other ways by the form of the media employed. In addition to advertising, researchers may solicit specific medical practitioners or clinics with a reputation for specializing in an area of medicine related to the pharmaceutical being tested. After consulting with practitioners, the researchers may be able to recruit patients of the practitioner that match the profile necessary for the pharmaceutical testing. Further screening may be necessary even after individuals are identified or have volunteered for participation in the study to determine if they suffer from conditions or are undergoing treatments that could compromise the results of the study.

Using the system of the present invention, populations of human subjects for pharmaceutical studies could be more readily identified by querying medical information contained in the medical information repository. With this information, researchers could identify the general geographic locations of large numbers of people who have an appropriate medical profile for the study. Similarly, the non-specific information obtained from the database could direct the search for human subjects to clinics and physicians that have patients with the appropriate medical profile. Researchers could approach clinics where information indicates they have patients that could participate in a particular study and request the assistance of physicians in evaluating or soliciting the participation of one or more of their patients. Using a medical information repository, researchers who use public advertisements to solicit participation could better target their advertising to populations where individuals are more likely to fit the profile.

The use of the medical information repository to solicit participants in a pharmaceutical study can expedite the approval process of the drug by shortening the time it takes to conduct trials, by providing better subjects that in turn result in a more reliable study, thereby improving the clinical testing portion of the approval process. Shortening the approval process provides an economic advantage to a pharmaceutical company. If the company developing the pharmaceutical is going to have proprietary rights in the drug, those proprietary rights will have a limited life span. In the United States, for example, the term of a patent for a research pharmaceutical is approximately 20 years from the date of filing of the patent application. However, the entire research and development process can take 14 or 15 years and cost hundreds of millions of dollars. The company's right to recoup this investment through the exclusive manufacture and sale of the drug will last only through the life of the patent, after which the drug will be available for generic reproduction from others who have not invested in its research and development. During the period of time in which a pharmaceutical company has exclusive rights to produce a new drug after it has been approved for use, the drug company can profit from the exclusive manufacture and distribution of the drug. With blockbuster drugs, the daily net profit can be very high. Thus, by expediting the approval process even a few days through the use of medical information repository to more efficiently locate individual interested in participating in clinical trials and studies, the present system can provide many millions of dollars of benefit to the pharmaceutical company prior to the termination of its exclusive manufacturing rights.

In the present legal climate, distribution of medical information is highly regulated. For example, in the United States privacy rules have been established to prevent the release of personal medical information without authorization. These rules apply to information that makes it possible to identify an individual based on the information. The most obvious forms of “individually identifiable” information would be a person's name or social security number. But other less obvious types of information could be used to “identify” someone, such as their date of birth, address, and occupation. The federal regulations require the consent of the person whose medical information is to be released or distributed, if it is possible to individually identify the person based on the information.

Before information from a medical information repository could be released to a research company hoping to identify individuals or groups of people or populations to solicit for pharmaceutical studies, the individuals would have to give consent or the medical information would have to be altered such that no person can be individually identified from the health information. “De-identifying” information requires more than simply removing names or addresses of patients, since in some circumstances, a combination of medical and related non-medical information could be used to individually identify a person whose information is being distributed. In order to legally distribute such information, a medical information repository would have to remove all “Identifying” information including: identifiers of the individual or of relatives, employers, or household of members of the individual associated with the record, which identifiers include names, geographic subdivisions, elements of dates related to any individual, telephone numbers, fax numbers, e-mail addresses, Social Security numbers, medical record numbers, health plan beneficiary numbers, account numbers, certificate license numbers, vehicle identifiers and serial numbers, including license plate numbers, device identifiers and serial numbers, URLs, IP addresses, biometric identifiers, photographic images, any other unique identifying number, characteristic or code. Where removing such information is not practical or renders the data useless, the medical information repository may instead release medical information upon condition that a person with appropriate knowledge and experience with generally accepted statistical and scientific principles has applied a “de-identifying” methodology to remove or make certain that no personally identifiable information is released from the repository.

The present invention contemplates the use of “de-identifying” methods and processes for allowing information from the present invention to be distributed for use in medical research. Furthermore, the benefits of the release of this information extends beyond pharmaceutical research to other areas, such as marketing and public health. The information distributed by the present invention can be deidentified at one of any number of points, including being deidentified at the originating source of the information, such as the PBM, or the clinic from which the medical information is being collected. It may also be deidentified in a process entirely separate from the originating source of the information, but in any case, the information must be deidentified prior to being released or distributed. Thus, the present invention assists a user in finding both personalized information of an individual for which there is authorization to obtain such information and provides the deidentified medical information that can be obtained without consent.

In one embodiment of the present invention, a research company desires to conduct clinical studies of a drug for treating pediatric patients with type II diabetes. In order to efficiently locate potential subjects, the research company queries a medical information repository associated with pharmaceutical benefit management groups. The medical information repository is able to search the database for any individuals under the age of 18 who are taking the drug glucophage, a drug commonly used to treat type II diabetics. In order to comply with privacy rules, the medical information repository does not release the identity of these individuals or the specifics of their medical records, but rather compiles a list of the physicians who wrote the prescriptions for glucophage. The list of these physicians is then provided to the research company, where such a list does not pose any risk of individually identifying a physician's patient. The physicians can then be contacted regarding this study and asked if they have patients they believe would be interested in participating. In this way, the process of locating potential participants in the study is expedited. Likewise, the database could be used to monitor compliance with drug regimens to determine if patients are willing to follow through with the taking of certain medication, based on subsequent prescription requests. Public health officials can access the database in order to track illnesses by evaluating the reports of physicians or prescriptions written by them.

### Program Storage Device

It will be apparent to those of ordinary skill having the benefit of this disclosure that any of the foregoing variations may be implemented by programming one or more suitable general-purpose computers having appropriate hardware. The programming may be accomplished through the use of a program storage device readable by the computer and encoding a program of instructions executable by the computer for performing the operations described above. The program storage device may take the form of, e.g., one or more floppy disks; a CD ROM or other optical disk; a magnetic tape; a read-only memory chip (ROM); and other forms of the kind well-kown in the art or subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage device and of the encoding of instructions are immaterial here.

The particular embodiments disclosed above are illustrative only, as the invention may be modified and practiced in different but equivalent manners apparent to those skilled in the art having the benefit of the teachings herein. Furthermore, no limitations are intended to the details of preferred environments or preferred embodiments herein shown, other than as described in the claims below. It is therefore evident that the particular embodiments may be altered or modified and all such variations are considered within the scope and spirit of the invention. Accordingly, the protection sought herein is as set forth in the claims below.

What is claimed and desired to be secured by Letters Patent is:

1. A method of searching for medical information executed by one or more computers comprising:
(a) receiving a request for medical information from a requester including identification of a subject;
(b) transmitting a query to a medical information repository for information pursuant to the request; and
(c) transmitting a response to the request including information based on the response to the query, the response being de-identified prior to transmission to remove any identifying information therein.

2. The method of claim 1, wherein the request further includes a signed information release.

3. The method of claim 2, wherein verifying the request includes verifying the signed information release.

4. The method of claim 1, further comprising
(a) utilizing the medical information as a surrogate for a physician-based medical record.

5. The method of claim 1, wherein the request is received by an internet website from an internet browser program executing on a computer communicating with the internet website.

6. The method of claim 1, wherein the query is transmitted to the medical information repository by an internet website communicating with the medical information repository.

7. The method of claim 5, wherein the computer communicating with the internet website operates according to input from a device capable of detecting the presence of an authorized user.

8. The method of claim 1, wherein verifying the request includes verifying the source of the request.

9. The method of claim 1, wherein the response includes medication information, further comprising
(a) determining a probable location of medical information based on the medication information.

10. The method of claim 1, wherein the response includes clinical information, further comprising
(a) determining a probable location of medical information based on the clinical information.

11. The method of claim 1, further comprising
(a) verifying the request

12. The method of claim 1, further comprising
(a) receiving a response to the query.

13. A method of claim 1, wherein the response is transmitted directly to the requestor.

14. A method of searching for medical information executed by a network comprising:
(a) requesting medical information including identification of a subject;
(b) verifying the request;
(c) querying a medical information repository for medical information about the identified subject;
(d) generating a response including any medical information about the subject contained in the medical information repository; and
(e) de-identifying the response to remove any identifying information from the response.

15. The method of claim 14, wherein the response includes medication information, further comprising
a) determining a probable location of medical information based on the medication information.

16. The method of claim 14, wherein the response includes clinical information, further comprising
(a) determining a probable location of medical information based on the clinical information.

17. The method of claim 14, further comprising
(a) utilizing the medical information as a surrogate for a physician-based medical record.

18. The method of claim 14, wherein requesting medical information about an identified subject is accomplished through an internet browser program executing on a computer communicating with an internet website.

19. The method of claim 14, wherein querying a medical information repository for medical information about the identified subject is accomplished through an Internet website communicating with a medical information repository.

20. The method of claim 14, wherein requesting medical information about an identified subject is accomplished by a computer operating according to input from a device capable of detecting the presence of an authorized user.

21. The method of claim 14, wherein verifying the request includes verifying the source of the request.

22. The method of claim 14, wherein verifying the request includes verifying a medical information release form.

23. A method for gathering and formatting medical information regarding an individual, and making that information available to a requester, the method comprising the steps of:
(a) searching at least one medical information repository for medical information regarding a group of preselected individuals;
(b) compiling and formatting at the site of the medical information repository the results of the search in a generic format ascertainable by requester;
(c) de-identifying the results of the search; and
(d) providing the compiled and de-identified results of at least one of the preselected individuals to a requester upon verification that the request is authorized.

24. A method of providing relevant medical data from a medical information repository to a requester in a format ascertainable by a requester, the method comprising the steps of:
(a) receiving a query regarding the medical history of an individual;
(b) searching and compiling medical information from third party sources;
(c) de-identifying the medical information; and
(d) providing the compiled and de-identified medical information to satisfy the query.
